(19) United States
(12) Patent Application Publication
(10) Pub. No.: US 2022/0036363 A1
(43) Pub. Date: Feb. 3, 2022

(54) IDENTIFICATION OF ANOMALOUS PAYMENT TERMINALS

(71) Applicant: MASTERCARD TECHNOLOGIES CANADA ULC, Vancouver (CA)

(72) Inventors: Carrie Ka Lai Cheung, Burnaby (CA); Sik Suen Chan, Richmond (CA); Xavier Lapunzina, Seneffe (BE); Paul Vanneste, Ottignies (BE)

(21) Appl. No.: 17/388,469

(22) Filed: Jul. 29, 2021

Related U.S. Application Data
(60) Provisional application No. 63/057,978, filed on Jul. 29, 2020.

(51) Int. Cl. G06Q 20/40; G06Q 20/32; G06Q 20/38

(52) U.S. Cl. CPC G06Q 20/4016; G06Q 20/4015; G06Q 20/3821; G06Q 20/3278; G06Q 20/4012

(57) ABSTRACT

A payment terminal evaluation device may include a network interface configured to receive data associated with each of a plurality of payment terminals. The data may include a plurality of data fields each having a respective value for a respective transaction processed by one of the plurality of payment terminals. Each payment terminal may be associated with one of a plurality of merchants. The payment terminal evaluation device may further include an electronic processor that may be configured to identify, based on the data, at least one of (i) a merchant of the plurality of merchants as an anomalous merchant and (ii) a payment terminal of the plurality of payment terminals as an anomalous payment terminal. The electronic processor may be further configured to transmit anomaly information to a communication device to cause the communication device to display the anomaly information.

### RELATED APPLICATIONS

This application claims priority to U.S. Provisional Patent Application No. 63/057,978, filed Jul. 29, 2020, the entire contents of which are hereby incorporated by reference.

### BACKGROUND

Contactless payment terminals are in use throughout the world to allow merchants to wirelessly accept payment from customers (e.g., via radio-frequency identification (RFID), near field communication (NFC), or the like) without physically swiping or inserting a payment card (e.g., credit card, debit card, etc.) or other payment device such as a key fob into the payment terminals. While contactless payment methods have many advantages over contact payments methods, the number of payment acceptance issues tends to be significantly higher for contactless payment methods than for contact payment methods.

### SUMMARY

As explained in greater detail herein, up to this point, contactless payment acceptance issues have been difficult to identify and address due to a lack of tooling devoted to acceptance issue identification and diagnosis for merchants that each operate one or more contactless payment terminals and/or acquirers who work with multiple merchants. Embodiments described herein relate to a payment terminal evaluation device configured to identify anomalous contactless payment terminals and provide information to acquirers and/or merchants regarding the health of their payment terminals.

One embodiment includes a payment terminal evaluation device that may include a network interface configured to receive data associated with each of a plurality of payment terminals. The data may include a plurality of data fields each having a respective value for a respective transaction processed by one of the plurality of payment terminals. Each payment terminal may be associated with one of a plurality of merchants. The payment terminal evaluation device may further include a data warehouse configured to store the data. The payment terminal evaluation device may further include an electronic processor coupled to the network interface and to the data warehouse. The electronic processor may be configured to identify, based on the data, at least one of (i) a merchant of the plurality of merchants as an anomalous merchant and (ii) a payment terminal of the plurality of payment terminals as an anomalous payment terminal. The electronic processor may be further configured to transmit anomaly information to a communication device to cause the communication device to display the anomaly information. The anomaly information may indicate that an anomaly has been identified with respect to the at least one of the anomalous merchant and the anomalous payment terminal.

Another embodiment includes a method of identifying at least one of an anomalous merchant and an anomalous payment terminal. The method may include receiving, via a network interface of a payment terminal evaluation device, data associated with each of a plurality of payment terminals. The data may include a plurality of data fields each having a respective value for a respective transaction processed by one of the plurality of payment terminals. Each payment terminal may be associated with one of a plurality of merchants. The method may further include storing the data in a data warehouse. The method may further include identifying, with an electronic processor of the payment terminal evaluation device and based on the data, at least one of (i) a merchant of the plurality of merchants as an anomalous merchant and (ii) a payment terminal of the plurality of payment terminals as an anomalous payment terminal. The method may further include transmitting, with the electronic processor, anomaly information to a communication device to cause the communication device to display the anomaly information. The anomaly information may indicate that an anomaly has been identified with respect to the at least one of the anomalous merchant and the anomalous payment terminal.

Another embodiment includes at least one non-transitory computer-readable medium having encoded thereon instructions which, when executed by at least one processor, cause the at least one processor to perform a method for identifying at least one of an anomalous merchant and an anomalous payment terminal. The method may include receiving, via a network interface of a payment terminal evaluation device, data associated with each of a plurality of payment terminals. The data may include a plurality of data fields each having a respective value for a respective transaction processed by one of the plurality of payment terminals. Each payment terminal may be associated with one of a plurality of merchants. The method may further include storing the data in a data warehouse. The method may further include identifying, with an electronic processor of the payment terminal evaluation device and based on the data, at least one of (i) a merchant of the plurality of merchants as an anomalous merchant and (ii) a payment terminal of the plurality of payment terminals as an anomalous payment terminal. The method may further include transmitting, with the electronic processor, anomaly information to a communication device to cause the communication device to display the anomaly information. The anomaly information may indicate that an anomaly has been identified with respect to the at least one of the anomalous merchant and the anomalous payment terminal.

Other aspects of the embodiments will become apparent by consideration of the detailed description and accompanying drawings.

### BRIEF DESCRIPTION OF THE DRAWINGS

FIG. 1 is a diagram that illustrates a system for communicating payment terminal data from contactless payment terminals and communicating payment terminal anomaly information to acquirers and/or merchants, according to embodiments described herein.

FIG. 2 is a block diagram that illustrates a payment terminal evaluation device of the system of FIG. 1, according to embodiments described herein.

FIG. 3 is a flowchart that illustrates a method for identifying anomalous contactless payment terminals and providing information to acquirers and/or merchants regarding the health of their payment terminals, according to embodiments described herein.

FIG. 4 illustrates a dashboard that is displayed on an acquirer/merchant communication device of the system of FIG. 1 in response to receiving health information from the payment terminal evaluation device of FIGS. 1 and 2 according to one example embodiment, according to embodiments described herein.

### DETAILED DESCRIPTION

Failed contactless payment attempts on a payment terminal may cause inconvenience for customers and for merchants. Therefore, it is desirable to reduce the amount of failed contactless payment attempts on payment terminals by identifying anomalies experienced by the payment terminals. However, up to this point, contactless payment acceptance issues have been difficult to identify and address due to a lack of tooling devoted to acceptance issue identification and diagnosis for merchants that each operate one or more contactless payment terminals and/or for acquirers who work with multiple merchants. For example, contactless payment acceptance issues may be caused by non-apparent underlying issues such as payment terminal management and configuration issues, incorrect reader usage, and/or incorrect setup of network data. Additionally, it may be difficult for a merchant and/or acquirer to determine if one or more individual payment terminals are behaving abnormally, for example, compared to other similar payment terminals. For example, a rejection rate (i.e., a failed payment attempt rate) of 5% for a given payment terminal may not, on its own, indicate that the payment terminal is faulty if such a rejection rate is expected and/or caused due to operator error.

In addition, issues with contactless payment terminals may be reported by some merchants too often (e.g., when only a few failed contactless payment attempts have occurred over a time period and such failures were primarily caused by merchant or customer error). On the other hand, issues with contactless payment terminals may not be reported by other merchants frequently enough (e.g., when a merchant is unaware that a contactless transaction failure rate is abnormally high). Also, in some cases, contactless payment acceptance issues may currently only be identified in a terminal-specific, reactive manner when contactless payment acceptance issues arise to the level of being perceptible by or overly inconvenient to a merchant or a customer.

To address the above-noted technological problem, embodiments described herein relate to a payment terminal evaluation device configured to identify anomalous contactless payment terminals and provide information to acquirers and/or merchants regarding the health of their payment terminals. For example, the payment terminal evaluation device provides information to each acquirer and/or merchant regarding their payment terminals that have been identified to be anomalous to allow each acquirer and/or merchant to address potential issues with their anomalous payment terminals.

Embodiments of the payment terminal evaluation devices described herein address the above-noted technological problem by proactively identifying contactless payment terminals whose behavior is unexpected in general or irregular when compared to aggregated behavior of other similar contactless payment terminals. This proactive identification of anomalous payment terminals may increase the overall functionality of payment terminals managed by an acquirer and/or merchant by allowing the acquirer and/or merchant to allocate resources (e.g., training staff, quality control staff, service technicians, and the like) to further analyze a limited number of payment terminals (i.e., the anomalous payment terminals). In other words, by being equipped with information that indicates that specific payment terminals are anomalous, acquirers and/or merchants can focus more of their attention on the anomalous payment terminals to improve the overall functionality of these anomalous payment terminals without wasting resources (e.g., training staff, quality control staff, service technicians, and the like) to overly monitor and/or analyze behavior of payment terminals that are determined to be in good health.

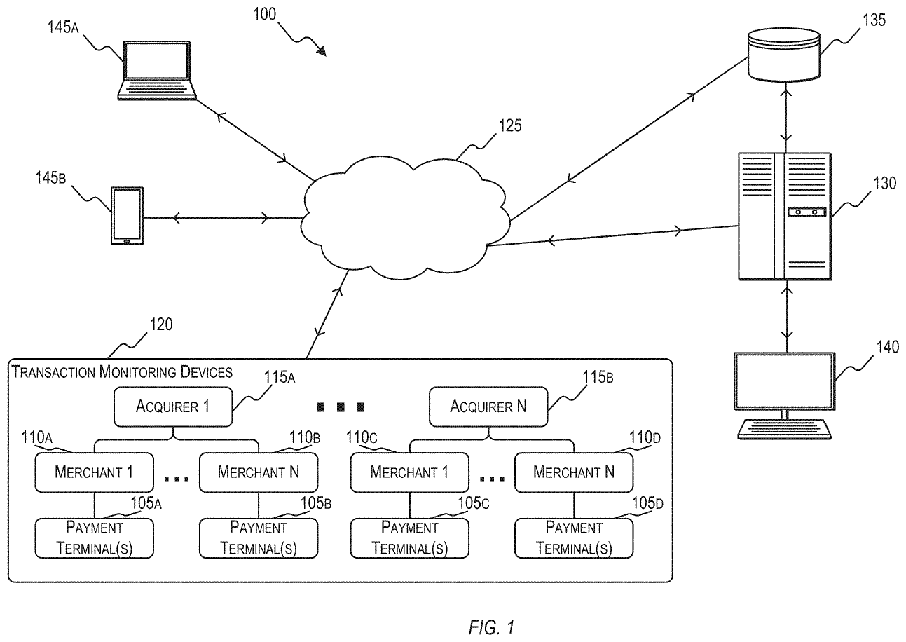

FIG. 1 illustrates a system 100 for communicating payment terminal data from contactless payment terminals and communicating payment terminal anomaly information to acquirers and/or merchants. The system 100 includes a plurality of payment terminals 105A-105D (e.g., contactless payment terminals) that are each associated with one of a plurality of merchants 110A-110D. Each merchant 110A-110D is associated with one of a plurality of acquirers 115A or 115B. In the following description, when explaining details of a payment terminal(s), a merchant(s), or an acquirer(s), a reference to payment terminal 105, merchant 110, and acquirer 115 may be respectively used. In some situations, each merchant 110 is an entity that provides good or services to customers (e.g., a clothing store, a restaurant, a dry cleaner, and the like). Each merchant 110 may use one or more payment terminals 105 at one or more locations throughout a region or throughout multiple regions. For example, the merchant 110A may be a restaurant chain that includes multiple locations across multiple states in the United States. In some situations, each of the multiple locations of the merchant 110A may use multiple payment terminals 105A. As another example, the merchant 110B may be a local clothing store with a single location that uses a single payment terminal 105B. As indicated in FIG. 1, each merchant 110 and its associated payment terminals 105 are associated with an acquirer 115. For example, each acquirer 115 is responsible for managing transactions that occur via the payment terminals 105 of the merchants 110 associated the respective acquirer 115. As indicated by the ellipses in FIG. 1, the amount of acquirers 115 shown is merely an example. More or fewer acquirers 115 may exist within the system 100. Similarly, the amount of merchants 110 shown to be associated with each acquirer 115 is merely an example. More or fewer merchants 110 may be associated with each acquirer 115. As indicated by the above explanation, each merchant 110 may be associated with and use one or more payment terminals 105.

As indicated in FIG. 1, one or more entities associated with each payment terminal 105 include a transaction monitoring device 120 configured to store data regarding each transaction and/or attempted transaction that occurs via each payment terminal 105. In some embodiments, the data includes a plurality of types of information each associated with a respective value for a respective payment terminal. For example, the plurality of types of information included in the data may include identification information about the payment terminal such as a payment terminal identification, a merchant identification, a merchant city, a merchant state, an acquirer identification, and/or the like. Additionally, the plurality of types of information included in the data may include transactional information about each transaction and/or attempted transaction that occurs via each payment terminal 105 such as a type of transaction (i.e., whether a transaction was a contactless transaction or a contact transaction), whether a transaction was approved or denied, a personal identification number (PIN) entered by a user to complete the transaction, a type of cardholder verification method (CVM) used to approve the transaction, and the like. The physical location and amount of devices that combine to act as transaction monitoring devices 120 may vary between different acquirers 115 and/or merchants as long as the data regarding transactions occurring via the payment terminals 105 is ultimately transmitted to a data warehouse 135 and evaluated by a payment terminal evaluation device 130 as explained in greater detail below.

As shown in FIG. 1, the system 100 also includes a network 125, the payment terminal evaluation device 130, a data warehouse 135, an evaluation device-side user interface 140 (e.g., a workstation), and acquirer/merchant communication devices 145A and 145B.

The network 125 is, for example, a wide area network (“WAN”) (e.g., a TCP/IP based network), a local area network (“LAN”), a neighborhood area network (“NAN”), a home area network (“HAN”), or personal area network (“PAN”) employing any of a variety of communications protocols, such as Wi-Fi, Bluetooth, ZigBee, etc. In some implementations, the network 125 is a cellular network, such as, for example, a Global System for Mobile Communications (“GSM”) network, a General Packet Radio Service (“GPRS”) network, a Code Division Multiple Access (“CDMA”) network, an Evolution-Data Optimized (“EV-DO”) network, an Enhanced Data Rates for GSM Evolution (“EDGE”) network, a 3GSM network, a 4GSM network, a 4G LTE network, a Digital Enhanced Cordless Telecommunications (“DECT”) network, a Digital AMPS (“IS-136/TDMA”) network, or an Integrated Digital Enhanced Network (“iDEN”) network, etc.

The connections between the elements shown in FIG. 1 and the network 125 and the connections between the elements themselves shown in FIG. 1 are, for example, wired connections, wireless connections, or a combination of wireless and wired connections.

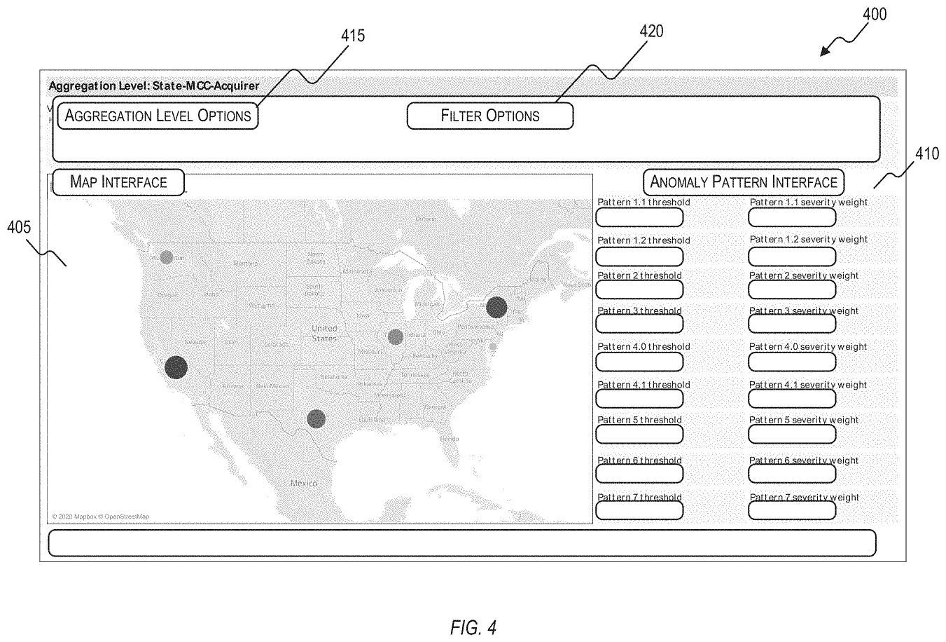

The acquirer/merchant communication devices 145 include, for example, a personal, desktop computer, a laptop computer 145A, a tablet computer, a personal digital assistant (“PDA”) (e.g., an iPod touch, an e-reader, etc.), a mobile phone (e.g., a smart phone) 145B, and the like. Each of the acquirer/merchant communication devices 145 is configured to communicatively connect to the payment terminal evaluation device 130 through the network 125 to receive information from the payment terminal evaluation device 130. As explained in greater detail below, the received information may include health information related to one or more payment terminals 105 associated with a respective acquirer 115 and/or merchant 110. In some embodiments, the health information includes anomaly information that identifies one or more payment terminals 105 and/or merchants 110 whose data is anomalous when compared to data of other payment terminals 105 and/or merchants 110 in similar regions and/or situations. For example, the acquirer/merchant communication devices 145 may download an application (i.e., “app”) to serve as a debugging tool for operators in the field to debug payment terminals 105 that are behaving anomalously as described in more detail below with respect to FIG. 4. Although the acquirer/merchant communication devices 145 and the transaction monitoring devices 120 are shown as and explained as separate devices previously herein, in some embodiments, one or more single devices or groups of devices may act as both an acquirer/merchant communication device 145 and a transaction monitoring device 120.

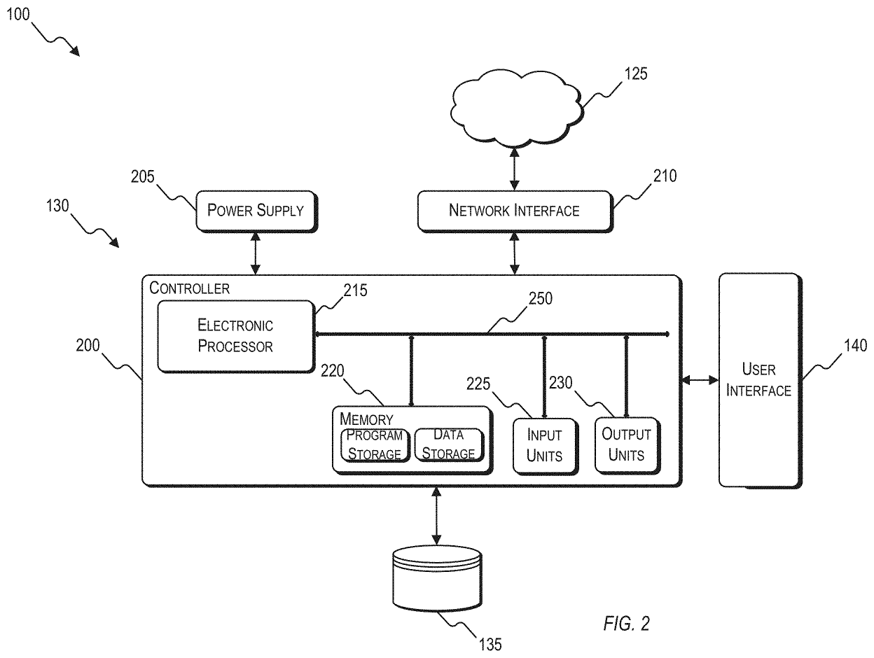

FIG. 2 is a block diagram that illustrates the payment terminal evaluation device 130 of the system 100 of FIG. 1. The payment terminal evaluation device 130 is electrically and/or communicatively connected to a variety of elements of the system 100. For example, the illustrated payment terminal evaluation device 130 is connected to the data warehouse 135 and the user interface 140. The payment terminal evaluation device 130 includes a controller 200, a power supply 205, and a network interface 210. The controller 200 includes combinations of hardware and software that are configured to, for example, identify anomalous contactless payment terminals 105 and provide information to acquirers 115 and/or merchants 110 regarding the health of their payment terminals 105. The controller 200 includes a plurality of electrical and electronic components that provide power, operational control, and protection to the components within the controller 200 and/or the system 100. For example, the controller 200 includes, among other things, an electronic processor 215 (e.g., a microprocessor, a microcontroller, or other suitable processing device), a memory 220, input units 225, and output units 230. The electronic processor 215, the memory 220, the input units 225, and the output units 230, as well as the various components connected to the controller 200 are connected by one or more control and/or data buses (e.g., common bus 250). The control and/or data buses are shown schematically in FIG. 2 for illustrative purposes.

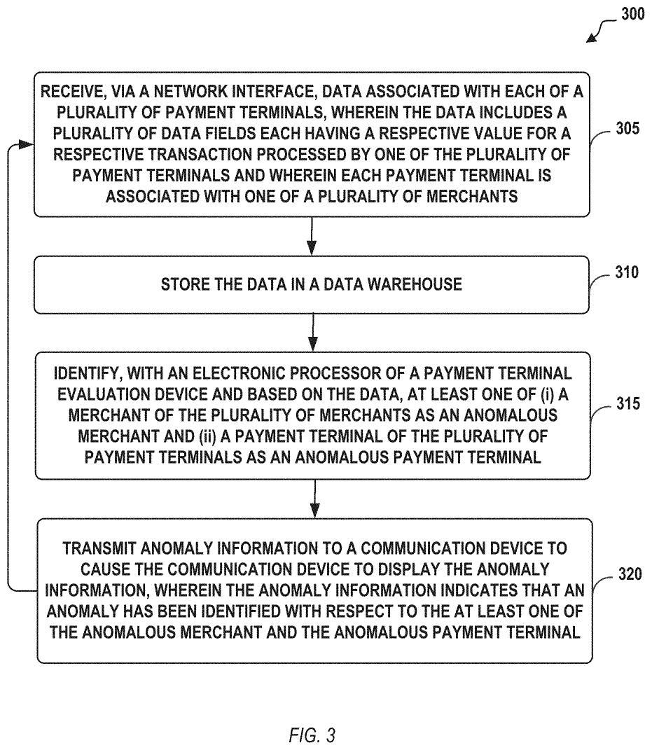

The memory 220 is a non-transitory computer-readable medium and includes, for example, a program storage area and a data storage area. The program storage area and the data storage area can include combinations of different types of memory, such as read-only memory (“ROM”), random access memory (“RAM”) (e.g., dynamic RAM [“DRAM”], synchronous DRAM [“SDRAM”], etc.), electrically erasable programmable read-only memory (“EEPROM”), flash memory, a hard disk, an SD card, or other suitable magnetic, optical, physical, electronic memory devices, or other data structures. In some examples, the program storage area may store the instructions executed by the electronic processor 215 during performance of the method 300 of FIG. 3 explained below.

The data warehouse 135 may be a database configured to store received data as explained herein. In some embodiments, the database 135 includes one or more of the different types of memory mentioned above with respect to the memory 220. For example, the data warehouse 135 includes a hard disk or other suitable magnetic, optical, physical, electronic memory devices, or other data structures.

The electronic processor 215 executes machine-readable instructions stored in the memory 220. For example, the electronic processor 215 may execute instructions stored in the memory 220 to perform the functionality described herein. In some examples, the electronic processor 215 performs machine learning to generating a machine learning function.

Machine learning generally refers to the ability of a computer program to learn without being explicitly programmed. In some embodiments, a computer program (for example, a learning engine) is configured to construct an algorithm (also referred to herein as a “machine learning function” or “statistical function”) based on inputs. Supervised learning involves presenting a computer program with example inputs and their desired outputs. The computer program is configured to learn a general rule that maps the inputs to the outputs from the training data it receives. Example machine learning engines include decision tree learning, association rule learning, artificial neural networks, classifiers, inductive logic programming, support vector machines, clustering, Bayesian networks, reinforcement learning, representation learning, similarity and metric learning, sparse dictionary learning, and genetic algorithms. Using one or more of the approaches described above, a computer program can ingest, parse, and understand data and progressively refine algorithms for data analytics. In some examples, the machine learning performed by the payment terminal evaluation device 130 in executing the functionality described herein is an ensemble machine learning model named XGBoost (eXtreme Gradient Boosting trees), a gradient boosting algorithm implemented for speed and performance. This learning model utilizes many (for example, thousands) of independent trees whose results are aggregated or otherwise combined (e.g. via voting) to produce a final prediction value. In some embodiments, the electronic processor 215 engages in machine learning to determine new anomaly patterns in addition to the below-described example anomaly patterns.

In some embodiments, the controller 200 or the network interface 210 includes one or more communications ports (e.g., Ethernet, serial advanced technology attachment [“SATA”], universal serial bus [“USB”], integrated drive electronics [“IDE”], etc.) for transferring, receiving, or storing data associated with the system 100 or the operation of the system 100. IN some embodiments, the controller 200 or the network interface 210 includes one or more wireless transceivers and antennas configured to allow the payment terminal evaluation device 130 to communicate wirelessly with other elements of the system 100. Software included in the implementation of the system 100 can be stored in the memory 220 of the controller 200. The software includes, for example, firmware, one or more applications, program data, filters, rules, one or more program modules, and other executable instructions. The controller 200 is configured to retrieve from memory and execute, among other things, instructions related to the functionality described herein.

The power supply 205 supplies a nominal AC or DC voltage to the controller 200 or other components or modules of the system 100. The power supply 205 is, for example, mains power having nominal line voltages between 100V and 240V AC and frequencies of approximately 50-60 Hz. The power supply 205 may be additionally or alternatively configured to supply lower voltages to operate circuits and components within the controller 200 or system 100.

The user interface 140 includes a combination of digital and analog input or output devices required to achieve a desired level of control and monitoring of the system 100. For example, the user interface 140 includes a display (e.g., a primary display, a secondary display, etc.) and input devices such as a mouse, touch-screen displays, a plurality of knobs, dials, switches, buttons, or other suitable input device. The display is, for example, a liquid crystal display (“LCD”), a light-emitting diode (“LED”) display, an organic LED (“OLED”) display, or other suitable display.

Although shown as separate elements in FIGS. 1 and 2, in some embodiments, the data warehouse 135 and the user interface 140 may be integrated into the payment terminal evaluation device 130. For example, the payment terminal evaluation device 130 may include the data warehouse and/or the user interface 140 within a single housing. As another example of the data warehouse 135 and/or the user interface 140 being integrated into the payment terminal evaluation device 130, the payment terminal evaluation device 130 may include components that function as shared components for one or more of the data warehouse 135, the user interface 140, and the payment terminal evaluation device 130 itself. For example, the network interface 210 may be used for transmitting and receiving data between external devices (e.g., transaction monitoring devices 120 and/or acquirer/merchant communication devices 145) and one or more of the data warehouse 135, the user interface 140, and the electronic processor 215. In alternate embodiments where the payment terminal evaluation device 130 is a separate entity from the data warehouse 135 and/or the user interface, each of the data warehouse 135, the user interface 140, and the electronic processor 215 may have their own dedicated network interface 210 and/or their own dedicates power supply 205. In other words, in some embodiments the data warehouse 135 and the user interface 140 may not be integrated into the payment terminal evaluation device 130.

In some embodiments, the acquirer/merchant communication devices 145 include at least some similar components as the payment terminal evaluation device 130 shown in FIG. 2. For example, the acquirer/merchant communication devices 145 include a power supply (e.g., a battery), a controller, a network interface, and a user interface. These components of the acquirer/merchant communication devices 145 function in a generally similar manner as described above with respect to the like-named components of the payment terminal evaluation device 130.

In some embodiments, the data warehouse 135 is configured to receive and store data from the transaction monitoring devices 120. The data includes data associated with each of a plurality of payment terminals 105. In some embodiments, the data is directly received from payment terminals 105 that could be considered transaction monitoring devices 120. Additionally or alternatively, the data may be collected from the payment terminals 105 by additional devices owned and/or operated by each merchant 110 or acquirer 115. The collected data may be sent to the data warehouse 135 in bulk. In other words, as mentioned previously herein, the physical location and amount of devices that combine to act as transaction monitoring devices 120 may vary between different merchants 110 and/or acquirers 115 as long as the data regarding the payment terminals 105 (e.g., data regarding transactions processed and/or attempted to be processed by the payment terminals 105) is ultimately transmitted to the data warehouse 135.

In some embodiments, the payment terminal evaluation device 130 (specifically, the electronic processor 215 of the payment terminal evaluation device 130) is configured to identify anomalous contactless payment terminals 105 and provide information to acquirers 115 and/or merchants 110 regarding the health of their payment terminals 105. In some embodiments, the payment terminal evaluation device 130 is configured to identify anomalous contactless payment terminals 105 by evaluating the data regarding the payment terminals 105 that is received and stored by the data warehouse 135. In some embodiments, the payment terminal evaluation device 130 is configured to provide information to acquirers 115 and/or merchants 110 regarding the health of the payment terminals 105 by transmitting health information to an acquirer/merchant communication device 145 to be displayed on the acquirer/merchant communication device 145.

FIG. 3 is a flowchart that illustrates a method 300 for identifying anomalous contactless payment terminals 105 and providing information to acquirers 115 and/or merchants 110 regarding the health of their payment terminals 105. The method 300 is described as being performed by the payment terminal evaluation device 130 (specifically, the electronic processor 215) of FIGS. 1 and 2. While a particular order of processing steps, message receptions, and/or message transmissions is indicated in FIG. 3 as an example, timing and ordering of such steps, receptions, and transmissions may vary where appropriate without negating the purpose and advantages of the examples set forth in detail throughout the remainder of this disclosure.

At block 305, the data warehouse 135 receives, via a network interface (e.g., network interface 210) data associated with each of a plurality of payment terminals 105. The received data may include a plurality of data fields (i.e., types of information) each associated with a respective value for a respective transaction processed by one of the plurality of payment terminals 105. Each payment terminal 105 may be associated with one of a plurality of merchants 110 as described previously herein. Similarly, each merchant 110 may be associated with one of a plurality of acquirers 115 as described previously herein. The data warehouse 135 may receive the data from one or more transaction monitoring devices 120 as described previously herein.

In some embodiments, the received data includes identification information and transaction authorization information that each include one or more types of information (i.e., data fields). Each data field may have a respective value for each transaction or attempted transaction on a payment terminal 105. In other words, for each transaction or attempted transaction that occurs on each payment terminal 105, values of a plurality of data fields may be recorded for future analysis by the payment terminal evaluation device 130. As used herein, the term “transaction” is intended to mean a successful transaction or an attempted transaction that ultimately failed or was rejected by a payment terminal 105.

In some embodiments, identification information allows the payment terminal evaluation device 130 to identify bibliographic information regarding a payment terminal 105. For example, data fields that include identification information may include one or more of a payment terminal identification number, a region (e.g., a city, state, province, country, etc.) where the payment terminal 105 is located, a merchant code corresponding to a merchant 110 with which the payment terminal 105 is associated, an acquirer code corresponding to an acquirer 115 with which the payment terminal 105 is associated, capability codes that indicate capabilities of the payment terminal 105 (e.g., whether the payment terminal 105 is configured to accept contactless payment), and the like. In some embodiments, the data warehouse 135 stores capability information of each type of payment terminal 105. In such embodiments, the electronic processor 215 may be configured to access the capability information of a certain payment terminal 105 based on received identification information for the payment terminal 105.

In some embodiments, transactional authorization information includes information regarding individual transactions that occurred on each payment terminal 105. For example, data fields that include transactional authorization information may include one or more of a transaction number/identification, a date and/or time of the transaction, a type of transaction (e.g., contactless, magnetic stripe, chip, whether the transaction was online or offline, and the like), a success indication (e.g., whether the transaction was successful/approved or unsuccessful/rejected), a dynamic card security code used to complete or attempt to complete the transaction, an indication of whether a personal identification number (PIN) was used in the transaction, an encrypted value of the PIN itself, a cryptogram used in the transaction, and the like.

At block 310, the data warehouse 135 stores the data received during the execution of block 305. At block 315, the electronic processor 215 of the payment terminal evaluation device 130 identifies, based on the data, at least one of (i) a merchant of the plurality of merchants 110 as an anomalous merchant and (ii) a payment terminal of the plurality of payment terminals 105 as an anomalous payment terminal. The electronic processor 215 is configured to identify the at least one of the anomalous merchant and the anomalous payment terminal by identifying one or more patterns of anomalous data associated with a merchant 110 or a payment terminal 105. In some embodiments, the electronic processor 215 identifies an anomalous merchant and/or anomalous payment terminal by identifying a pattern of anomalous transactions that have occurred on a given payment terminal 105 and/or on one or more payment terminals 105 associated with a given merchant 110.

One way to identify an anomalous transaction includes the electronic processor 215 identifying inconsistencies in the received data for a given transaction. For example, the electronic processor 215 may flag a transaction as anomalous in response to determining that the received data indicates that the type of transaction was contactless when the received capability codes (or the stored capability information) of the payment terminal 105 indicate that the payment terminal 105 is not capable of processing contactless transactions. As another example, the electronic processor 215 may flag a transaction as anomalous in response to determining that the received data indicates that a particular cardholder verification method (CVM) was performed when the received capability codes (or the stored capability information) of the payment terminal 105 indicate that the payment terminal 105 is not capable of performing the particular CVM. As yet another example, the electronic processor 215 may flag a transaction as anomalous in response to determining that the received data indicates that a personal identification number (PIN) was entered but the PIN data is not included in the received data.

Another way to identify an anomalous transaction includes the electronic processor 215 identifying missing data in the received data for a given transaction. For example, received data for a given transaction may be missing a data field altogether or may include no data in a data field in which data is expected given other characteristics of the payment terminal 105 and/or transaction. For example, the electronic processor 215 may flag a transaction as anomalous in response to determining that the received data is missing a cryptogram that is expected to be included during the transaction. In some embodiments, the general absence of data from a payment terminal 105 may be indicative of an anomaly (e.g., no data received or less data received than expected). For example, the electronic processor 215 may flag a given payment terminal 105 as anomalous due to an absence of transaction data in response to determining that less transaction data is being received than is expected. The electronic processor 215 may determine that less transaction data is being received than expected (i) based on historical data corresponding to the given payment terminal 105 and/or (ii) based on a comparison to the number of transactions processed by other similar payment terminals 105 over the same period of time. The electronic processor 215 may also flag a given payment terminal 105 as anomalous if no transaction data is received from its associated transaction monitoring device 120 over a predetermined period of time. Such an anomaly may indicate a faulty payment terminal 105 and/or a faulty transaction monitoring device 120 associated with the payment terminal 105.

Another way to identify an anomalous transaction includes the electronic processor 215 identifying unexpected or unlikely data in the received data for a given transaction. For example, the electronic processor 215 may flag a transaction as anomalous in response to determining that the received data includes a dynamic card security code (e.g., a dCVC3) that includes three identical digits (e.g., 000, 999, etc.). Because the dynamic card security code is a dynamically generated sequence designed to be systematically different, a sequence of three identical digits may be considered suspicious.

After identifying anomalous transactions, the electronic processor 215 may aggregate anomalous transaction data at one or more different aggregation levels (e.g., for each payment terminal 105 or for each merchant 110) to determine whether a payment terminal 105 and/or a merchant 110 is exhibiting a pattern of anomalous behavior. For example, the electronic processor 215 may determine a percentage of the overall transactions processed by a given payment terminal 105 or by the payment terminals 105 associated with a given merchant over a predetermined time period (e.g., one month) that were identified as anomalous according to each of the above-noted example identifications of anomalous transactions. When the percentage of any identified anomaly is above a respective threshold (i.e., reference value), the electronic processor 215 determines that the payment terminal 105 and/or merchant 110 has exhibited a pattern of anomalous behavior.

As is evident from the above examples, because the electronic processor 215 is configured to identify numerous different anomalies that occur in a given transaction or across multiple transactions, each payment terminal 105 and/or merchant 110 may exhibit one or more patterns of anomalous behavior. For example, the electronic processor 215 may determine that a first payment terminal 105 had 1% of its transactions over a one-month period with a dynamic card security code with three identical digits and 9% of its transactions over the one-month period with a missing cryptogram. The electronic processor 215 may also determine that a second payment terminal 105 had 10% of its transactions over the one-month period with inconsistent CVM data and 8% of its transactions over the one-month period with a missing cryptogram. In this example, the threshold to indicate an anomalous pattern may be 5% for the missing cryptogram data field and 7% for each of the dynamic card security code data field and inconsistent CVM data data field. Accordingly, the electronic processor 215 identifies that the first payment terminal 105 has exhibited an anomalous pattern with respect to the missing cryptogram data field but not with respect to the dynamic card security code data field. Additionally, the electronic processor 215 identifies that the second payment terminal 105 has exhibited an anomalous pattern with respect to both the missing cryptogram data field and the inconsistent CVM data data field.

The above example percentages of anomalous transactions refer to percentages of anomalous transactions on a per payment terminal basis (i.e., aggregated at the payment terminal level). However, the electronic processor 215 may additionally or alternatively calculate percentages of anomalous transactions on a per merchant basis across multiple payment terminals 105 owned and/or operated by the merchant 110 (i.e., aggregated at the merchant level). Additionally or alternatively, the electronic processor 215 may calculate percentages of anomalous transactions on a per merchant basis across multiple payment terminals 105 owned and/or operated by the merchant 110 within a certain regions such as a state in the United States (i.e., aggregated at the merchant-state level). In some embodiments, the threshold percentages may be the same as each other or may be different from each other depending on the level of aggregation of the received data. Additional aggregation levels with respect to which data may be aggregated and analyzed are also possible (e.g., payment terminal and/or merchant data compared to all payment terminals 105 and/or merchants 110 associated with the same acquirer 115 or compared to all payment terminals 105 and/or merchants 110 regardless of associated with an acquirer 115).

In some embodiments, the electronic processor 215 is configured to identify a pattern of anomalous data of a payment terminal 105 and/or merchant 110 without determining that an individual transaction is anomalous. For example, the electronic processor 215 may determine a contactless transaction approval rate for a given payment terminal 105 and/or merchant 110. The electronic processor 215 may determine one or more contactless transaction approval rates by dividing an amount of approved contactless transactions over a time period (e.g., one month) by one or more of a total amount of approved transactions by the payment terminal 105 and/or merchant 110, an amount of approved online transactions by the payment terminal 105 and/or merchant 110, and an amount of approved offline transactions by the payment terminal 105 and/or merchant 110 over the time period. In some embodiments, whether a transaction is an online transaction or an offline transaction indicates an authorization mode of the transaction. For example, during an online transaction, a request is made for a real-time online authorization from an issuer host of the payment card (or other payment device such as a key fob or an application on a smart phone) for approval of the transaction. On the other hand, during an offline transaction such a request for real-time online authorization from the issuer host is not made. In some embodiments, the issuer host also acts as an acquirer 115. The overall amounts of approved transactions may include approved contactless transactions as well as other types of approved transactions that are not contactless (e.g., magnetic stripe transactions where a credit/debit card is swiped through a magnetic card reader, chip transactions where a credit/debit card is inserted into a card reader, etc.).

In some embodiments, the one or more contactless transaction approval rates of a given payment terminal 105 and/or merchant 110 are compared to a threshold (i.e., reference value) to determine whether the payment terminal 105 and/or merchant 110 has exhibited a pattern of anomalous behavior based on its contactless acceptance approval rate. In other words, when the contactless acceptance approval rate of a payment terminal 105 and/or merchant 110 is below the threshold, the electronic processor 215 determines that the payment terminal 105 and/or merchant 110 has exhibited a pattern of anomalous behavior.

As another example of identifying a pattern of anomalous data of a payment terminal 105 and/or merchant 110 without determining that an individual transaction is anomalous, the electronic processor 215 may determine that a payment terminal 105 and/or merchant 110 that has not processed any contactless transactions within a time period (e.g., one month) is anomalous. Similar to the above example regarding contactless transaction approval rates, an amount of payment terminals 105 owned and/or operated by a certain merchant 110 that have not processed any contactless transactions within the time period may be compared to a threshold (i.e., reference value) to determine whether the merchant 110 has exhibited a pattern of anomalous behavior relative to other merchants 110.

In some embodiments, the electronic processor 215 is configured to identify a pattern of anomalous data of a payment terminal 105 and/or merchant 110 in other manners. For example, the electronic processor 215 may identify a pattern of anomalous data based on a payment terminal 105 sending inconsistent data associated with different transactions over a period of time. For example, the electronic processor 215 may determine that the same payment terminal 105 previously transmitted data including first capability codes for a first transaction but then later transmitted data for a different transaction including second capability codes. If the capabilities of the payment terminal 105 are configured to remain constant over time, receipt of different capability codes may be flagged by the electronic processor 215 as anomaly. In other words, the electronic processor 215 may flag the payment terminal 105 as an anomalous payment terminal in response to determining that the payment terminal 105 has transmitted two or more distinct capability codes in its history of processed transactions over a time period (e.g., one month).

In some embodiments, the electronic processor 215 may determine a percentage of anomalous payment terminals 105 associated with each merchant 110 (e.g., based on transaction approval rate and/or not processing any contactless transactions) to identify anomalous merchants 110. For example, merchants 110 with an anomalous terminal percentage above a threshold (i.e., reference value), such as 5%, may be identified as an anomalous merchant. In this example, the electronic processor 215 may identify the merchant 110 as anomalous despite the overall transaction approval rate of the merchant 110 being above the respective threshold and/or the amount of payment terminals 105 owned and/or operated by the merchant 110 that did not process a contactless transaction being below the respective threshold. In other words, this anomaly identification method may identify and flag a merchant 110 as anomalous that may not have been identified if anomaly data was only aggregated and analyzed at the merchant level rather than at the payment terminal level with respect to each merchant 110.

In some embodiments, the respective thresholds described above that are used by the electronic processor 215 to identify anomalies are predetermined and stored in the memory 220 of the payment terminal evaluation device 130. In some embodiments, the respective thresholds are user programmable and may be adjusted by a user via the user interface 140 or via the acquirer/merchant communication device 145. In some embodiments, the respective thresholds are programmed to adjust automatically based on seasonality (i.e., time of the year). For example, during different times of the year, such as holidays during which increased purchases are typically made by consumers, the respective thresholds may be programmed to be automatically adjusted to account for increased transactions, increased expected anomalies (e.g., due to new customers adopting contactless payment methods), and/or the like.

In some embodiments, the respective thresholds are dynamically determined by the electronic processor 215 based on aggregated data from the data warehouse 135. For example, the electronic processor 215 determines a respective threshold by determining an average value, a standard deviation, a median, etc. for a data field across all payment terminals 105 (i) associated with a merchant 110 or acquirer 115, (ii) located within a certain region, (iii) associated with a merchant 110 or acquirer 115 and located within a certain region, or (iv) based on some other data aggregation level. As another example, the electronic processor 215 determines a respective threshold by determining an average value, a standard deviation, a median, etc. for a data field across all payment terminals 105 for which data has been received and stored in the data warehouse 135. As a more specific example, the electronic processor 215 may determine that an average contactless transaction approval rate across all payment terminals 105 is 92%. In some embodiments, the electronic processor 215 may identify payment terminals 105 and/or merchants 110 with contactless transaction approval rates below the average contactless approval rate (i.e., below 92%) as anomalous. In some embodiments, the electronic processor 215 determines one or more respective thresholds in alternate manners such as identifying anomalous payment terminals 105 and/or merchants 110 based on the payment terminal 105 and/or merchant 110 having a data field in the bottom 10% or the top 10% of an aggregated data field. In other words, the electronic processor 215 identifies anomalous payment terminals 105 and/or merchants 110 in response to detecting a relative outlier in received data when compared to aggregated data from multiple payment terminals 105 and/or merchants 110 in the same data field.

In some embodiments, the electronic processor 215 implements a scoring system to determine a severity level of an anomaly, a severity level of an anomalous payment terminal, and/or a severity level of an anomalous merchant. Different identified anomalies may be considered more or less severe by the electronic processor 215. Additionally, the electronic processor 215 may determine that an anomaly is more severe based on the prevalence of the anomaly and/or the amount by which a characteristic (e.g., a value of a data field) has exceeded above or has decreased below a respective threshold.

In one example embodiment of the scoring system, the electronic processor 215 adds points to an anomaly score of each payment terminal 105 and/or merchant 110 depending on different types of anomalies identified with respect to the payment terminal 105 and/or merchant 110. As an example of different types of anomalies being considered more or less severe than each other, the electronic processor 215 may be configured such that a dynamic card security code data field anomaly pattern as explained above is less severe than a contactless acceptance approval rate anomaly pattern as explained above. As another example, the electronic processor 215 may be configured such that the contactless acceptance approval rate anomaly pattern is less severe than an inconsistent data anomaly pattern (e.g., inconsistent received CVM data data field compared to received payment terminal capability codes). Each payment terminal 105 and/or merchant 110 may initially begin with an anomaly score of zero before the electronic processor 215 begins analyzing received data for anomalies. In some embodiments, the electronic processor 215 is configured to increase the anomaly score of each payment terminal 105 and/or merchant 110 as anomalies are detected. Accordingly, as the anomaly score increases, the anomaly score is configured to indicate a higher severity level of one or more anomalies and a lower health of the payment terminal 105 and/or merchant 110. Continuing these examples, the electronic processor 215 may increase an anomaly score of a payment terminal 105 and/or merchant 110 by five points in response to identifying a dynamic card security code data field anomaly pattern of the payment terminal 105 and/or merchant 110. The electronic processor 215 may increase an anomaly score of a payment terminal 105 and/or merchant 110 by ten points in response to identifying a contactless acceptance approval rate anomaly pattern of the payment terminal 105 and/or merchant 110. The electronic processor 215 may increase an anomaly score of a payment terminal 105 and/or merchant 110 by fifteen points in response to identifying an inconsistent data anomaly pattern of the payment terminal 105 and/or merchant 110.

Similarly, the electronic processor 215 may increase an anomaly score of a payment terminal 105 and/or merchant 110 by a varying amount of points based on a difference between a value associated with the data of the payment terminal 105 and/or merchant 110 and a respective threshold to which the value is being compared. For example, in addition to adding ten points to the anomaly score of a payment terminal 105 and/or merchant 110 for which a contactless acceptance approval rate anomaly pattern was identified, the electronic processor 215 adds another ten points to the anomaly score in response to determining that the contactless acceptance approval rate of the payment terminal 105 and/or merchant 110 is below the threshold rate by over 10%. In some embodiments, the anomaly score of the payment terminal 105 and/or merchant 110 is adjusted by the electronic processor 215 in proportion to an amount that a value associated with the data of the payment terminal 105 and/or merchant 110 is above or below a respective threshold. For example, the electronic processor 215 may increase the anomaly score of the payment terminal 105 and/or merchant 110 by one point for each integer percentage that the contactless acceptance approval rate of the payment terminal 105 and/or merchant 110 is below a threshold. For example, the electronic processor 215 increases the anomaly score of the payment terminal 105 and/or merchant 110 by three points in response to determining that the contactless acceptance approval rate of the payment terminal 105 and/or merchant 110 is 3% below the threshold rate.

As indicated by the above examples, the electronic processor 215 may be configured to determine a severity level of identified anomalous payment terminals 105 and/or merchants 110 based one or more of (i) an amount of anomalies and/or anomaly patterns associated with a payment terminal 105 and/or merchant 110, (ii) a type of each individual anomaly and/or anomaly pattern associated with a payment terminal 105 and/or merchant 110, and (iii) a severity level of each individual anomaly and/or anomaly pattern associated with a payment terminal 105 and/or merchant 110.

In some embodiments, the electronic processor 215 is configured to determine trends in the severity level of identified anomalies, anomaly patterns, and/or in the anomaly scores for payment terminals 105 and/or merchants 110 over time (e.g., month-to-month, week-to-week, or the like). For example, the electronic processor 215 is configured to determine whether a payment terminal 105 and/or merchant 110 has an anomaly and/or anomaly pattern that is getting more severe as time progresses (e.g., further from a respective threshold or occurring more often) or less severe as time progresses (e.g., closer to the respective threshold or occurring less often). Similarly, the electronic processor 215 may be configured to determine whether the overall anomaly score of the payment terminal 105 and/or merchant 110 has increased over a time period or has decreased over a time period.

In some embodiments, the electronic processor 215 is configured to categorize payment terminals 105 and/or merchants 110 into categories based on their respective anomaly scores. For example, payment terminals 105 and/or merchants 110 with an anomaly score of zero may be categorized as non-anomalous payment terminals 105 and/or merchants 110. Payment terminals 105 and/or merchants 110 with an anomaly score of one to fourteen may be categorized as low anomaly level payment terminals 105 and/or merchants 110. Payment terminals 105 and/or merchants 110 with an anomaly score of fourteen to twenty-nine may be categorized as medium anomaly level payment terminals 105 and/or merchants 110. Payment terminals 105 and/or merchants 110 with an anomaly score of thirty or greater may be categorized as high anomaly level payment terminals 105 and/or merchants 110.

The examples of anomalies, patterns, thresholds, scoring systems, anomaly levels, and related concepts explained herein are merely examples. In other embodiments, the electronic processor 215 may identify anomalies by analyzing additional and/or alternative data received from the transaction monitoring devices 120. Similarly, different thresholds may be used, and the electronic processor 215 may use other methods to identify anomalous payment terminals 105 and/or merchants 110 than the methods explained herein. For example, the electronic processor 215 may aggregate data at any aggregation level (e.g., merchant level, acquirer level, region-based, some combination of these aggregation levels, all received data, and the like).

At block 320, the payment terminal evaluation device 130 transmits health information (e.g., anomaly information) to one or more acquirer/merchant communication devices 145 to cause the acquirer/merchant communication device 145 to display the health information. In some embodiments, the payment terminal evaluation device 130 transmits the health information to the acquirer/merchant communication device 145 via the same network interface 210 that received transaction data from the transaction monitoring devices 120. In other embodiments, the payment terminal evaluation device 130 transmits the health information to the acquirer/merchant communication device 145 via a different network interface 210. In other words, in some embodiments, the data warehouse 135 may have its own, network interface that is separate from the network interface 210 of the payment terminal evaluation device 130.

The transmitted anomaly information included in the health information indicates that an anomaly and/or anomaly pattern has been identified with respect to at least one of the anomalous merchant and the anomalous payment terminal. In some embodiments, the payment terminal evaluation device 130 transmits health information of each payment terminal 105 and merchant 110 associated with the acquirer 115 and/or merchant 110 that owns and/or operates the acquirer/merchant communication device 145. For example, the health information includes anomaly information related to identified anomalies and also includes general status information (e.g., number of transactions, types of transactions, etc.) related to payment terminals 105 and/or merchants 110 where no anomalies were identified. In other embodiments, the payment terminal evaluation device 130 only transmits information regarding payment terminals 105 and/or merchants 110 that were identified as being anomalous (i.e., payment terminals 105 and/or merchants 110 having an anomaly score above zero).

FIG. 4 illustrates a dashboard 400 that is displayed on the acquirer/merchant communication device 145 in response to receiving health information from the payment terminal evaluation device 130 according to one example embodiment. The dashboard 400 may be configured to show any combination of data related to payment terminals 105 and/or merchants 110 such that the acquirer 115 and/or merchant 110 may evaluate the health of payment terminals 105 and/or merchants 110. In other words, the dashboard 400 provides a convenient user interface to allow the acquirer 115 and/or merchant 110 to identify anomalous payment terminals 105 and/or merchants 110 associated with the acquirer 115 and/or merchant 110. The dashboard 400 may be provided via an application (i.e., “app”) that is downloadable by the acquirer/merchant communication device 145. The downloaded app may serve as a debugging tool for acquirers/merchants and their affiliates to use in the field to debug payment terminals 105 that are behaving anomalously.

As shown in FIG. 4, the dashboard 400 includes a map interface 405 and an anomaly pattern interface 410. The map interface 405 may visually represent anomaly information. For example, in FIG. 4, the dots on the map interface 405 represent an amount of identified anomalies, a percentage of identified anomalies, an anomaly score of payment terminals 105 and/or merchants 110, and/or the like. Larger dots in California and New York may represent more identified anomalies than smaller dots in Washington or Wyoming. For example, the large dots in California and New York may represent a high anomaly level for payment terminals 105 and/or merchants 110 in California and New York. The medium dots in Washington and Illinois may represent a medium anomaly level for payment terminals 105 and/or merchants 110 in Washington and Illinois. The small dots in Wyoming and Delaware may represent a low anomaly level for payment terminals 105 and/or merchants 110 in Wyoming and Delaware. In some embodiments, the map interface 405 (or another interface) displays the locations of payment terminals 105 and/or merchants 110 in different colors to indicate health information of each of the payment terminals 105 and/or merchants 110. For example, low anomaly level payment terminals 105 and/or merchants 110 may be displayed with green dots. Medium anomaly level payment terminals 105 and/or merchants 110 may be displayed with yellow dots. High anomaly level payment terminals 105 and/or merchants 110 may be displayed with red dots.

The map interface 405 may be updated by the acquirer/merchant communication device 145 in response to user inputs that alter anomaly pattern thresholds and/or weights in the anomaly pattern interface 410. For example, using the anomaly pattern interface 410, the user (e.g., an employee of the acquirer 115 and/or merchant 110) may adjust thresholds and weighting of individual anomalies and/or anomalous patterns that were discussed previously herein. Such adjustments may be communicated by the acquirer/merchant communication device 145 to the payment terminal evaluation device 130 to affect the anomaly scores determined by the payment terminal evaluation device 130 for each payment terminal 105 and/or merchant 110. Based on the adjusted thresholds and weights, the payment terminal evaluation device 130 may re-calculate anomaly scores for each payment terminal 105 and/or merchant 110 and transmit the re-calculated anomaly scores (i.e., re-calculated health information including anomaly information) for display on the dashboard 400.

As shown in FIG. 4, the dashboard 400 includes aggregation level options 415 and filter options 420. When selected, the aggregation level options 415 allow the user to select how the anomaly information is aggregated when the payment terminal evaluation device 130 evaluates a payment terminal 105 and/or a merchant 110. For example, as explained previously herein, payment terminal data of each payment terminal 105 may be compared against payment terminal data of (i) payment terminals 105 located within the same region (e.g., state or province), (ii) payment terminals owned and/or operated by the same merchant 110 or acquirer 115, (iii) payment terminals that meet both (i) and (ii), (iv) all payment terminals 105 regardless of association with merchant 110 and/or acquirer 115, or the like. Based on the selected aggregation level, the map interface 405 may be updated accordingly to display information regarding anomalous payment terminals 105 and/or merchants 110. In some embodiments, the acquirer/merchant communication device 145 may communicate a selected aggregation level to the payment terminal evaluation device 130. This communication allows the payment terminal evaluation device 130 to re-identify anomalous payment terminals 105 and/or merchants 110 based on the selected aggregation level. The payment terminal evaluation device 130 may then transmit updated anomaly information to the acquirer/merchant communication device 145 for display. In other embodiments, the acquirer/merchant communication device 145 may locally perform this re-identification based on the selected aggregation level.

The filter options 420 allow the user to specify which anomaly information should be displayed. For example, the filter options 420 allow the user to drill down to view more specific details related to a selected payment terminal 105, a selected merchant 110, a selected region (e.g., state or province), a selected anomaly and/or anomalous pattern, or the like. As one example, in response to selecting “California” in the filter options 420, the map interface 405 is updated to display a zoomed-in view of California and the location of any anomalous payment terminals 105 and/or merchants 110 in California. The user may further drill down by selecting a sub-region such as a city, a particular merchant 110, a particular payment terminal 105, and/or the like. In some embodiments, the user may use the filter options 420 to remove the map interface 405 from the dashboard 400 to view other interfaces that display anomaly information. For example, the other interfaces may include charts, tables, bar graphs, or the like that display one or more of an amount of anomalous transactions per payment terminal 105 and/or merchant 110, a type of anomaly detected for each payment terminal 104 and/or merchant, an anomaly score (e.g., a severity level) of identified anomalous payment terminals 105 and/or merchants 110, and/or the like.

The health information including anomaly information displayed in the dashboard 400 may be displayed, aggregated, and filtered in any number of ways and is not limited to the examples explained previously herein.

As indicated in FIG. 3, the method 300 may be repeated by the electronic processor 215 to continue identifying anomalous payment terminals 105 and/or merchants 110 as new data is received from transaction monitoring devices 120 and/or as new thresholds, weights, and aggregation levels are selected by users via acquirer/merchant communication devices 145.

As explained previously herein, the payment terminal evaluation device 130 proactively identifies contactless payment terminals 105 whose behavior is unexpected in general or irregular when compared to aggregated behavior of other similar contactless payment terminals 105. The communication of this proactive identification of anomalous payment terminals 105 to the acquirer/merchant communication device 145 may increase the overall functionality of payment terminals 105 managed by an acquirer 115 and/or merchant 110 by allowing the acquirer 115 and/or merchant 110 to allocate resources (e.g., training staff, quality control staff, and the like) to further analyze a limited number of payment terminals 105 (i.e., the anomalous payment terminals). In other words, by being equipped with information that indicates that specific payment terminals 105 are anomalous through use of the dashboard 400, acquirers 115 and/or merchant 110 can focus their attention on the anomalous payment terminals to improve the overall functionality of these anomalous payment terminals without wasting resources to monitor and/or analyze behavior of payment terminals 105 that are determined to be in good health.

Thus, embodiments described herein provide, among other things, a payment terminal evaluation device configured to identify one or more anomalous (i.e., faulty) payment terminals and transmit health information to a communication device configured to provide a dashboard to allow a user to better manage and maintain their payment terminals.

It is to be understood that the embodiments are not limited in its application to the details of the configuration and arrangement of components set forth herein or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more electronic processors, such as a microprocessor and/or application specific integrated circuits (“ASICs”). As such, it should be noted that a plurality of hardware and software based devices, as well as a plurality of different structural components, may be utilized to implement the embodiments. For example, “servers” and “computing devices” described in the specification can include one or more electronic processors, one or more computer-readable medium modules, one or more input/output interfaces, and various connections (e.g., a system bus) connecting the various components.

Various features and advantages are set forth in the following claims.

What is claimed is:

1. A payment terminal evaluation device comprising:
a network interface configured to receive data associated with each of a plurality of payment terminals, wherein the data includes a plurality of data fields each having a respective value for a respective transaction processed by one of the plurality of payment terminals and wherein each payment terminal is associated with one of a plurality of merchants;
a data warehouse configured to store the data; and
an electronic processor coupled to the network interface and to the data warehouse, the electronic processor configured to
identify, based on the data, at least one of (i) a merchant of the plurality of merchants as an anomalous merchant and (ii) a payment terminal of the plurality of payment terminals as an anomalous payment terminal, and
transmit anomaly information to a communication device to cause the communication device to display the anomaly information, wherein the anomaly information indicates that an anomaly has been identified with respect to the at least one of the anomalous merchant and the anomalous payment terminal.

2. The payment terminal evaluation device of claim 1, wherein the electronic processor is configured to identify the anomalous merchant by determining, based on the data, at least one of:
that a first aggregated value of first data for the anomalous merchant is above or below a first threshold of the first data, wherein the first threshold is determined based on a second aggregated value of the first data for multiple merchants; and
that an amount of anomalous transactions of a first type that have occurred on payment terminals of the anomalous merchant exceeds a second threshold, wherein the second threshold is determined based on an aggregated value of anomalous transactions of the first type that have occurred on payment terminals of the multiple merchants.

3. The payment terminal evaluation device of claim 2, wherein the multiple merchants are at least one of (i) each associated with a single acquirer, (ii) located within a certain region, and (iii) both (i) and (ii); and
wherein the electronic processor is configured to dynamically determine the first threshold by determining at least one of an average, a median, and a standard deviation for a data field of the first data for the multiple merchants.

4. The payment terminal evaluation device of claim 3, wherein the first aggregated value includes at least one of a first overall transaction approval rate, a first contactless transaction approval rate, a first amount of approved transactions, a first amount of rejected transactions, and a first amount of contactless transactions; and
wherein the first threshold includes at least one of a second overall transaction approval rate, a second contactless transaction approval rate, a second amount of approved transactions, a second amount of rejected transactions, and a second amount of contactless transactions.

5. The payment terminal evaluation device of claim 1, wherein the electronic processor is configured to identify the anomalous payment terminal by determining, based on the data, at least one of:
that a first aggregated value of first data for the anomalous payment terminal is above or below a first threshold of the first data, wherein the first threshold is determined based on a second aggregated value of the first data for multiple payment terminals; and
that an amount of anomalous transactions of a first type that have occurred on the anomalous payment terminal exceeds a second threshold, wherein the second threshold is determined based on an aggregated value of anomalous transactions of the first type that have occurred on the multiple payment terminals.

6. The payment terminal evaluation device of claim 5, wherein the multiple payment terminals are at least one of (i) each associated with a single merchant or acquirer, (ii) located within a certain region, and (iii) both (i) and (ii); and
wherein the electronic processor is configured to dynamically determine the first threshold by determining at least one of an average, a median, and a standard deviation for a data field of the first data for the multiple payment terminals.

7. The payment terminal evaluation device of claim 6, wherein the first aggregated value includes at least one of a first overall transaction approval rate, a first contactless transaction approval rate, a first amount of approved transactions, a first amount of rejected transactions, and a first amount of contactless transactions; and
wherein the first threshold includes at least one of a second overall transaction approval rate, a second contactless transaction approval rate, a second amount of approved transactions, a second amount of rejected transactions, and a second amount of contactless transactions.

8. The payment terminal evaluation device of claim 1, wherein the electronic processor is configured to transmit the anomaly information to the communication device via the network interface.

9. The payment terminal evaluation device of claim 1, wherein the data includes identification information, transaction authorization information, or a combination thereof;
wherein the identification information includes at least one of a payment terminal region of each respective payment terminal, a merchant code corresponding to a merchant with which each respective payment terminal is associated, and a capability code configured to indicate a capability of each respective payment terminal; and
wherein the transaction authorization information includes at least one of a transaction identification of the respective transaction, a date of the respective transaction, a time of the respective transaction, a type of the respective transaction, an indication of whether the respective transaction was successful, and a dynamic card security code used during the respective transaction.

10. The payment terminal evaluation device of claim 1, wherein the electronic processor is configured to identify the at least one of the anomalous merchant and the anomalous payment terminal by determining that a plurality of anomalous transactions associated with the at least one of the anomalous merchant and the anomalous payment terminal have occurred; and
wherein the electronic processor is configured to identify at least one anomalous transaction of the plurality of anomalous transactions by identifying an inconsistency in data received for the at least one anomalous transaction.

11. The payment terminal evaluation device of claim 10, wherein the inconsistency in the data received for the at least one anomalous transaction indicates at least one of:
a type of transaction performed by a respective payment terminal that is not supported by the respective payment terminal according to a capability code of the respective payment terminal;
a type of cardholder verification method (CVM) performed by the respective payment terminal that is not supported by the respective payment terminal according to the capability code of the respective payment terminal;
that a personal identification number (PIN) was entered but PIN data is not included in the data received for the at least one anomalous transaction; and
an absence of a certain type of the data received for the at least one anomalous transaction compared to previously received data for previous transactions performed by the respective payment terminal.

12. A method of identifying at least one of an anomalous merchant and an anomalous payment terminal, the method comprising:
receiving, via a network interface of a payment terminal evaluation device, data associated with each of a plurality of payment terminals, wherein the data includes a plurality of data fields each having a respective value for a respective transaction processed by one of the plurality of payment terminals and wherein each payment terminal is associated with one of a plurality of merchants;
storing the data in a data warehouse;
identifying, with an electronic processor of the payment terminal evaluation device and based on the data, at least one of (i) a merchant of the plurality of merchants as an anomalous merchant and (ii) a payment terminal of the plurality of payment terminals as an anomalous payment terminal; and
transmitting, with the electronic processor, anomaly information to a communication device to cause the communication device to display the anomaly information, wherein the anomaly information indicates that an anomaly has been identified with respect to the at least one of the anomalous merchant and the anomalous payment terminal.

13. The method of claim 12, wherein identifying the anomalous merchant includes determining, based on the data, at least one of:
that a first aggregated value of first data for the anomalous merchant is above or below a first threshold of the first data, wherein the first threshold is determined based on a second aggregated value of the first data for multiple merchants; and
that an amount of anomalous transactions of a first type that have occurred on payment terminals of the anomalous merchant exceeds a second threshold, wherein the second threshold is determined based on an aggregated value of anomalous transactions of the first type that have occurred on payment terminals of the multiple merchants.

14. The method of claim 13, wherein the multiple merchants are at least one of (i) each associated with a single acquirer, (ii) located within a certain region, and (iii) both (i) and (ii), and further comprising:
dynamically determining, with the electronic processor, the first threshold by determining at least one of an average, a median, and a standard deviation for a data field of the first data for the multiple merchants.

15. The method of claim 12, wherein identifying the anomalous payment terminal includes determining, based on the data, at least one of:
that a first aggregated value of first data for the anomalous payment terminal is above or below a first threshold of the first data, wherein the first threshold is determined based on a second aggregated value of the first data for multiple payment terminals; and
that an amount of anomalous transactions of a first type that have occurred on the anomalous payment terminal exceeds a second threshold, wherein the second threshold is determined based on an aggregated value of anomalous transactions of the first type that have occurred on the multiple payment terminals.

16. The method of claim 15, wherein the multiple payment terminals are at least one of (i) each associated with a single merchant or acquirer, (ii) located within a certain region, and (iii) both (i) and (ii), and further comprising:
dynamically determining, with the electronic processor, the first threshold by determining at least one of an average, a median, and a standard deviation for a data field of the first data for the multiple payment terminals.

17. At least one non-transitory computer-readable medium having encoded thereon instructions which, when executed by at least one processor, cause the at least one processor to perform a method for identifying at least one of an anomalous merchant and an anomalous payment terminal, the method comprising acts of:
receiving, via a network interface of a payment terminal evaluation device, data associated with each of a plurality of payment terminals, wherein the data includes a plurality of data fields each having a respective value for a respective transaction processed by one of the plurality of payment terminals and wherein each payment terminal is associated with one of a plurality of merchants;
storing the data in a data warehouse;
identifying, with an electronic processor of the payment terminal evaluation device and based on the data, at least one of (i) a merchant of the plurality of merchants as an anomalous merchant and (ii) a payment terminal of the plurality of payment terminals as an anomalous payment terminal; and
transmitting, with the electronic processor, anomaly information to a communication device to cause the communication device to display the anomaly information, wherein the anomaly information indicates that an anomaly has been identified with respect to the at least one of the anomalous merchant and the anomalous payment terminal.

18. The at least one non-transitory computer-readable medium of claim 17, wherein identifying the anomalous merchant includes determining, based on the data, at least one of:
that a first aggregated value of first data for the anomalous merchant is above or below a first threshold of the first data, wherein the first threshold is determined based on a second aggregated value of the first data for multiple merchants; and
that an amount of anomalous transactions of a first type that have occurred on payment terminals of the anomalous merchant exceeds a second threshold, wherein the second threshold is determined based on an aggregated value of anomalous transactions of the first type that have occurred on payment terminals of the multiple merchants.

19. The at least one non-transitory computer-readable medium of claim 18, wherein the multiple merchants are at least one of (i) each associated with a single acquirer, (ii) located within a certain region, and (iii) both (i) and (ii), and further comprising:
dynamically determining, with the electronic processor, the first threshold by determining at least one of an average, a median, and a standard deviation for a data field of the first data for the multiple merchants.

20. The at least one non-transitory computer-readable medium of claim 17, wherein identifying the anomalous payment terminal includes determining, based on the data, at least one of:
that a first aggregated value of first data for the anomalous payment terminal is above or below a first threshold of the first data, wherein the first threshold is determined based on a second aggregated value of the first data for multiple payment terminals; and
that an amount of anomalous transactions of a first type that have occurred on the anomalous payment terminal exceeds a second threshold, wherein the second threshold is determined based on an aggregated value of anomalous transactions of the first type that have occurred on the multiple payment terminals.
